(19) United States
(12) Patent Application Publication
(10) Pub. No.: US 2007/0294349 A1
(43) Pub. Date: Dec. 20, 2007

(54) PERFORMING TASKS BASED ON STATUS INFORMATION

(75) Inventors: David M. Chickering, Redmond, WA (US); Timothy S. Paek, Redmond, WA (US); Christopher A. Meek, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/424,462

(22) Filed: Jun. 15, 2006

(51) Int. Cl. G06F 15/16

(52) U.S. Cl. 709/205

(57) ABSTRACT

Tasks based on status information are performed based on a voice query across a computer network. Information in the voice query is associated with a particular contact entity and status information is accessed in order to perform the tasks.

### BACKGROUND

The discussion below is merely provided for general background information and is not intended to be used as an aid in determining the scope of the claimed subject matter.

Personal digital assistants (PDA), mobile devices and phones are used with ever increasing frequency by people in their day-to-day activities. With the increase in processing power now available for microprocessors used to run these devices, the functionality of these devices is increasing, and in some cases, merging. For instance, many portable phones now can be used to access and browse the Internet as well as can be used to store personal information such as addresses, phone numbers and the like.

In view that these computing devices are being used with increasing frequency, it is beneficial to provide an easy interface for the user to enter information into the computing device and/or access information across a network using the device. Unfortunately, due to the desire to keep these devices as small as possible in order that they are easily carried, conventional input methods and accessing tasks are limited due to the limited surface area available on housings of the devices.

### SUMMARY

The Summary and Abstract are provided to introduce some concepts in a simplified form that are further described below in the Detailed Description. The Summary and Abstract are not intended to identify key features or essential features of the claimed subject matter, nor is it intended to be used as an aid in determining the scope of the claimed subject matter.

Tasks based on status information are performed based on a voice query across a computer network. Information in the voice query is associated with a particular contact entity and status information is accessed in order to perform the tasks.

### BRIEF DESCRIPTION OF THE DRAWINGS

FIG. 1 is a block diagram of a network-based service environment.

FIG. 2 is a block diagram of a communication architecture.

FIG. 3 is a flow chart of a method for processing voice queries.

FIG. 4 is a diagram of a contact list.

FIG. 5 is a block diagram of a general computing environment.

FIG. 6 is a block diagram of a mobile computing device.

FIG. 7 is a plan view of a phone.

### DETAILED DESCRIPTION

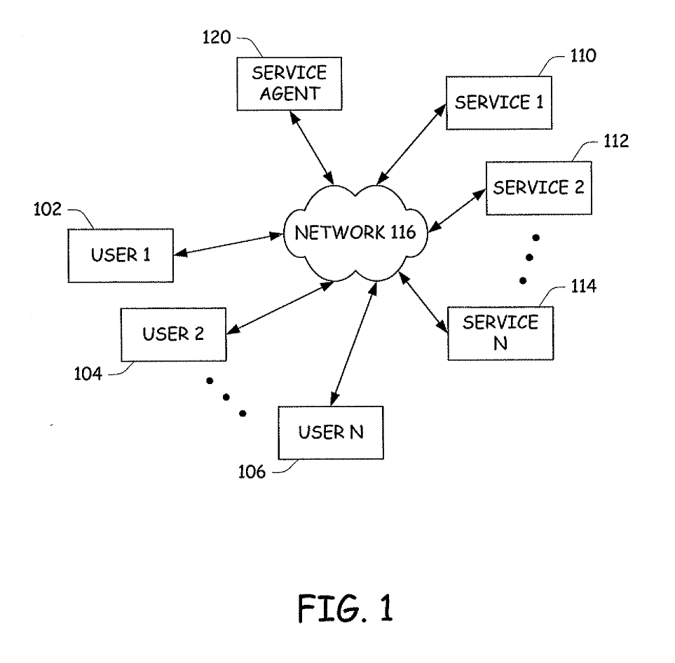

FIG. 1 is a block diagram of a network-based service environment 100. Service environment 100 includes a plurality of users, for example user 102, user 104 and user 106. Each of the plurality of users 102, 104 and 106 can access a plurality of services, for example services 110, 112 and 114 through a network 116. Additionally, each of the users 102, 104 and 106 can connect with other users through network 116. The users 102, 104 and 106 can connect with service agent 120 through network 116.

Service agent 120 can store information related to each of the users 102, 104 and 106 as well as facilitate communication among each of the users 102, 104, 106 and each of the services 110, 112 and 114. Services 110, 112 and 114 can provide various sources of information for access by users 102, 104 and 106. For example, information can relate to stock quotes, weather, travel information, news, music, advertisements, etc. Service agent 120 can include personal information for each of the users 102, 104 and 106 to customize access to services 110, 112 and 114. For example, user 102 may wish to only receive particular stock quotes from service 112. Service agent 120 can store this information.

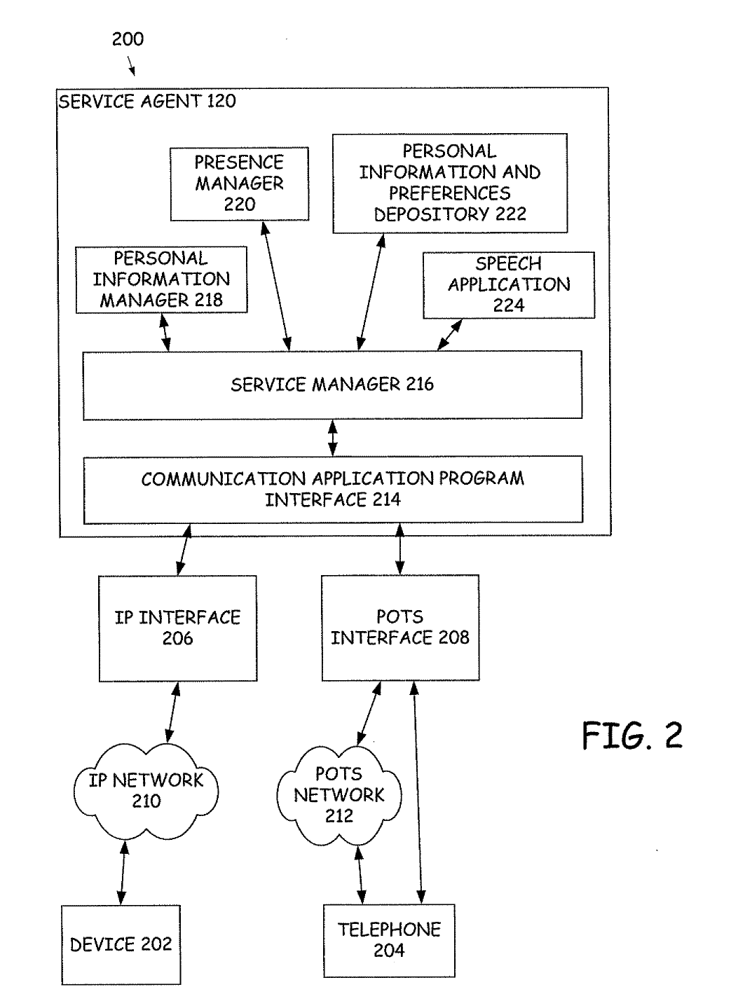

FIG. 2 illustrates an exemplary communication architecture 200 with a service agent 120 as discussed above. In one embodiment, service agent 120 can be implemented on a general purpose computer. Agent 120 receives communication requests and messages from a user (for example users 102, 104 and 106) and performs tasks based on the requests and messages. The messages can be routed to a destination. The user can access agent 120 through any device, telephone, remote personal information manager, etc. that can connect to agent 120.

Information from the user can take many forms including web-based data entry, real time voice (for example from a simple telephone or through a voice over Internet protocol source), real time text (such as instant messaging), non-real time voice (for example a voicemail message) and non-real time text (for example through short message service (SMS) or email). Tasks are automatically performed by agent 120, for example speech recognition, accessing services, scheduling a calendar, voice dialing, managing contact information, managing messages, call routing and interpreting a caller identification.

Agent 120 represents a single point of contact for a user or a group of users. Thus, if a person wishes to contact a user or group of users, communication requests and messages are passed through agent 120. In this manner, the person need not have all contact information for another user or group of users. The person only needs to contact agent 120, which can handle and route incoming communication requests and messages. Additionally, agent 120 is capable of initiating a dialog with the person, if the user or group of users is unavailable.

A user can contact agent 120 through a number of a different modes of communication. Generally, agent 120 can be accessed through a computing device 202 (for example a mobile device, laptop or desktop computer, which herein represents various forms of computing devices having a display screen, a microphone, a camera, a touch sensitive panel, etc., as required based on the form of input), or through a phone 204 wherein communication is made audibly or through tones generated by phone 204 in response to keys depressed and wherein information from agent 120 can be provided audibly back to the user.

More importantly though, agent 120 is unified in that whether information is obtained through device 202 or phone 204, agent 120 can support either mode of operation. Agent 120 is operably coupled to multiple interfaces to receive communication messages. IP interface 206 receives information using packet switching technologies, for example using TCP/IP (Transmission Control Protocol/Internet Protocol). POTS (Plain old Telephone System, also referred to as Plain Old Telephone Service) interface 208 can interface with any type of circuit switching system including a Public Switch Telephone Network (PSTN), a private network (for example a corporate Private Branch exchange (PBX)) and/or combinations thereof. Thus, POTS interface 208 can include an FXO (Foreign Exchange Office) interface and an FXS (Foreign Exchange Station) interface for receiving information using circuit switching technologies.

IP interface 206 and POTS interface 208 can be embodied in a single device such as an analog telephony adapter (ATA). Other devices that can interface and transport audio data between a computer and a POTS can be used, such as “voice modems” that connect a POTS to a computer using a telephone application program interface (TAPI).

In this manner, agent 120 serves as a bridge between the Internet domain and the POTS domain. In one example, the bridge can be provided at an individual personal computer with a connection to the Internet. Additionally, agent 120 can operate in a peer-to-peer manner with any suitable device, for example device 202 and/or phone 204. Furthermore, agent 120 can communicate with one or more other agents and/or services.

As illustrated in FIG. 2, device 202 and agent 120 are commonly connected, and separately addressable, through a network 210, herein a wide area network such as the Internet. It therefore is not necessary that device 202 and agent 120 be physically located adjacent each other. Device 202 can transmit data, for example speech, text and video data, using a specified protocol to IP interface 206. In one embodiment, communication between client 202 and IP interface 206 uses standardized protocols, for example TCP/IP and SIP with RTP (Session Initiator Protocol with Realtime Transport Protocol).

Access to agent 120 through phone 204 includes connection of phone 204 to a wired or wireless telephone network 212 that, in turn, connects phone 204 to agent 120 through a FXO interface. Alternatively, phone 204 can directly connect to agent 120 through a FXS interface.

Both IP interface 206 and POTS interface 208 connect to agent 120 through a communication application program interface (API) 214. One implementation of communication API 214 is Microsoft Real-Time Communication (RTC) Client API, developed by Microsoft Corporation of Redmond, Wash. Another implementation of communication API 214 is the Computer Supported Telecommunication Architecture (ECMA-269/ISO 120651), or CSTA, an ISO/ECMA standard. Communication API 214 can facilitate multimodal communication applications, including applications for communication between two computers, between two phones and between a phone and a computer. Communication API 214 can also support audio and video calls, text-based messaging and application sharing. Thus, agent 120 is able to initiate communication to device 202 and/or phone 204. Alternatively, another agent and/or service can be contacted by agent 120.

To unify communication control for POTS and IP networks, agent 120 is able to translate POTS protocols into corresponding IP protocols and vice versa. Some of the translations are straightforward. For example, agent 120 is able to translate an incoming phone call from POTS into an invite message (for example a SIP INVITE message) in the IP network, and a disconnect message (for example a SIP BYE message), which corresponds to disconnecting a phone call in POTS.

However, some of the IP-POTS translations involve multiple cohesive steps. For example, a phone call originated in POTS may reach the user on the IP network with agent 120 using an ATA connected to an analog phone line. The user may direct the agent 120 to transfer the communication to a third party reachable only through a POTS using a refer message (for example a SIP REFER message). The ATA fulfills the intent of the SIP REFER message using call transfer conventions for the analog telephone line. Often, call transfer on analog phone lines involves the following steps: (1) generating a hook flash, (2) waiting for a second dial tone, (3) dialing the phone number of the third party recipient, and (4) detecting the analog phone call connection status and generating corresponding SIP messages (e.g., a ringing connection in an analog phone corresponds to a REFER ACCEPTED and a busy tone to a REFER REJECTED, respectively).

Agent 120 also includes a service manager 216, a personal information manager (PIM) 218, a presence manager 220, a personal information and preferences depository 222 and a speech application 224. Service manager 216 includes logic to handle communication requests and messages from communication API 214. This logic can perform several communication tasks including answering, routing and filtering calls, recording voice and video messages, analyzing and storing text messages, arranging calendars, schedules and contacts as well as facilitating individual and conference calls through both IP interface 206 and POTS interface 208.

Service manager 216 also can define a set of rules for which to contact a user and interact with users connecting to agent 120 via communication API 214. Rules that define how to contact a user are referred to as “Find Me/Follow Me” features for communication applications. For example, a user associated with agent 120 can identify a home phone number, an office phone number, a mobile phone number and an email address within personal information and preferences depository 222 for which agent 120 can attempt to contact the user. Additionally, persons contacting agent 120 can have different priority settings such that, for certain persons, calls can always be routed to the user.

Service manager 216 can also perform various natural language processing tasks. For example, service manager 216 can access speech application 224 that includes a recognition engine used to identify features in speech input. Recognition features for speech are usually words in the spoken language. In one particular example, a grammar can be used to recognize text within a speech utterance. As is known, recognition can also be provided for handwriting and/or visual inputs.

Service manager 216 can use semantic objects to access information in PIM 218. As used herein, “semantic” refers to a meaning of natural language expressions. Semantic objects can define properties, methods and event handlers that correspond to the natural language expressions.

A semantic object provides one way of referring to an entity that can be utilized by service manager 216. A specific domain entity pertaining to a particular domain application can be identified by any number of different semantic objects with each one representing the same domain entity phrased in different ways.

The term semantic polymorphism can be used to mean that a specific entity may be identified by multiple semantic objects. The richness of the semantic objects, that is the number of semantic objects, their interrelationships and their complexity, corresponds to the level of user expressiveness that an application would enable in its natural language interface. As an example of polymorphism “John Doe”, “VP of NISDI”, and “Jim's manager” all refer to the same person (John Doe) and are captured by different semantic objects PersonByName, PersonByJob, and PersonByRelationship, respectively.

Semantic objects can also be nested and interrelated to one another including recursive interrelations. In other words, a semantic object may have constituents that are themselves semantic objects. For example, “Jim's manager” corresponds to a semantic object having two constituents: “Jim” which is a “Person” semantic object and “Jim's Manager” which is a “PersonByRelationship” semantic object. These relationships are defined by a semantic schema that declares relationships among semantic objects. In one embodiment, the schema is represented as a parent-child hierarchical tree structure. For example, a “SendMail” semantic object can be a parent object having a “recipient” property referencing a particular person that can be stored in PIM 218. Two example child objects can be represented as a “PersonByName” object and a “PersonByRelationship” object that are used to identify a sender of a mail message from PIM 218.

Using service manager 216, PIM 218 can be accessed based on actions to be performed and/or semantic objects. As appreciated by those skilled in the art, PIM 218 can include various types and structures of data that can manifest themselves in a number of forms such as, but not limited to, relational or objected oriented databases, Web Services, local or distributed programming modules or objects, XML documents or other data representation mechanism with or without annotations, etc. Specific examples include contacts, appointments, text and voice messages, journals and notes, audio files, video files, text files, databases, etc. Agent 120 can then provide an output using communication API 214 based on the data in PIM 218 and actions performed by service manager 216.

PIM 218 can also include an indication of priority settings for particular contacts. The priority settings can include several levels of rules that define how to handle communication messages from a particular contact. For example, one contact can have a high priority (or VIP) setting in which requests and/or messages are always immediately forwarded to the user associated with agent 120. Contacts with a medium priority setting will take a message from the contact if the user is busy and forward an indication of a message received to the user. Contacts with a low setting will have messages taken that can be access by the user at a later time. In any event, numerous settings and rules for a user's contacts can be set within PIM 218, which are not limited to the situations discussed above.

Presence manager 220 includes an indicator of a user's availability. For example, a presence indicator can be “available”, “busy”, “stepped out”, “be right back”, “on the phone”, “online” or “offline”. Presence manager 220 can interact with service manager 216 to handle communication messages based on the indicator. In addition to the presence indicators identified above, presence manager 220 also includes a presence referred to as “delegated presence”.

When presence manager 220 indicates that presence is delegated, agent 120 serves as an automatic message handler for a user or group of users. Agent 120 can automatically interact with persons wishing to contact the user or group of users associated with agent 120. For example, agent 120 can route an incoming call to a user's cell phone, or prompt a person to leave a voicemail message. Alternatively, agent 120 can arrange a meeting with a person based on information contained in a calendar of the PIM 218. When agent 120 is associated with a group of users, agent 120 can route a communication request in a number of different ways. For example, the request can be routed based on a caller identification of a person, based on a dialog with the person or otherwise.

Personal information and preferences depository 222 can include personal information for a particular user including contact information such as email addresses, phone numbers and/or mail addresses. Additionally, depository 222 can include information related to audio and/or electronic books, music, personalized news, weather information, traffic information, stock information and/or services that provide these specific types of information.

Additionally, depository 222 can include customized information to drive speech application 224. For example, depository 222 can include acoustic models, user voice data, voice services that a user wishes to access, a history of user behavior, models that predict user behavior, modifiable grammars for voice services, personal data such as log-in names and passwords and/or voice commands.

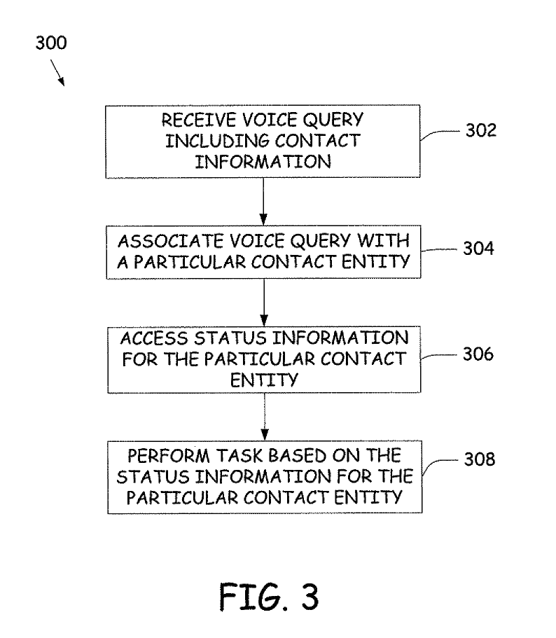

FIG. 3 is a flow chart of the method 300 for processing voice queries from a user. At step 302 a voice query containing contact information is received. The voice query can identify a specific person, a specific group and/or a specific status information. For example, the query could be “call whoever is not busy”, “Is Danny online?”, “Which of my colleagues are online?”, “Call any of my best-friends”. At step 304, the voice query is associated with a particular contact entity from a plurality of contact entities based on the contact information. The contact entity can be a single person or a group of persons. The contact entities can be stored within PIM 218. At step 306, status information for the particular contact entity is accessed. The status information can be accessed using communication API 214 across a network. At step 308, a task is performed based on the status information for the particular contact entity. In one example, the task can include forming a voice connection (for example over an IP network or POTS network). If the contact entity is busy, a connection can be made at a later time.

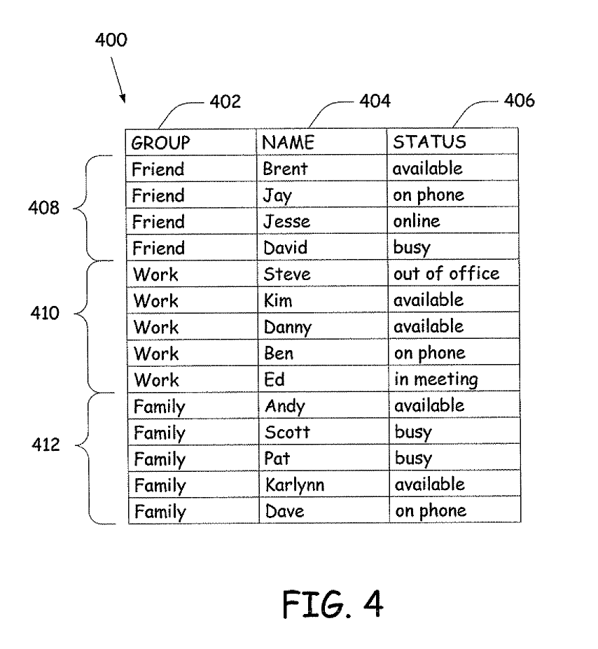

FIG. 4 is a list 400 of a plurality of contacts, which can for example be stored in personal information manager 218. List 400 includes a group indication 402, a name indication 404 and a status indication 406. Status indication 406 is set by each contact as an indication of presence, for example the presence indicators discussed above with respect to presence manager 220. The groups include a friends group 408, a work group 410 and a family group 412.

Using list 400, several scenarios are available for a user to facilitate communication with different users through agent 120. For example, a user can issue a voice query related to a group, a name, a status and/or combinations thereof. Tasks are performed based on status information obtained for the group/name identified. The status information includes a presence indicator and can be obtained across various disparate services, for example MSN Messenger service, Yahoo! Messenger service or Google Talk service.

In one scenario, John is shopping at a department store and finds a pair of sunglasses he likes, but does not want to pay too much at the store and might find a better deal online. John can access agent 120 (through device 202 or phone 204) and issue a voice query such as “Let me know which friends are online.” Speech application 224 recognizes the voice query and provides an indication of what John said to service manager 216. Service manager 216 then accesses PIM 218, which has list 400. Group 408, which is the friend group, is accessed. Jesse in list 400 is online, so service agent 120 forms a voice connection between John and Jesse based on contact information stored in PIM 218 about Jesse. John can then ask Jesse to help him find the lowest online price for the desired sunglasses.

In another scenario, John would like to begin a brainstorming session with persons at work. He can then issue a voice query, “Begin a conference call with people available at work.” In this situation, group 410, the work group, is accessed. Kim and Danny are both available, so a conference call is begun by agent 120 using Kim and Danny's contact information.

Service agent 120 can also be used to notify a user when a particular person or persons are available. For example, if John wants to talk with Pat, he can issue a voice query to agent 120 such as, “Is Pat available?” In list 400, Pat's status is listed as busy. Agent 120 can respond to John with this information. When Pat's status is available, agent 120 can contact John and form a connection between Pat and John. As a result, John has quick access to status information for his contacts simply by issuing a voice query and without the need for a graphical user interface.

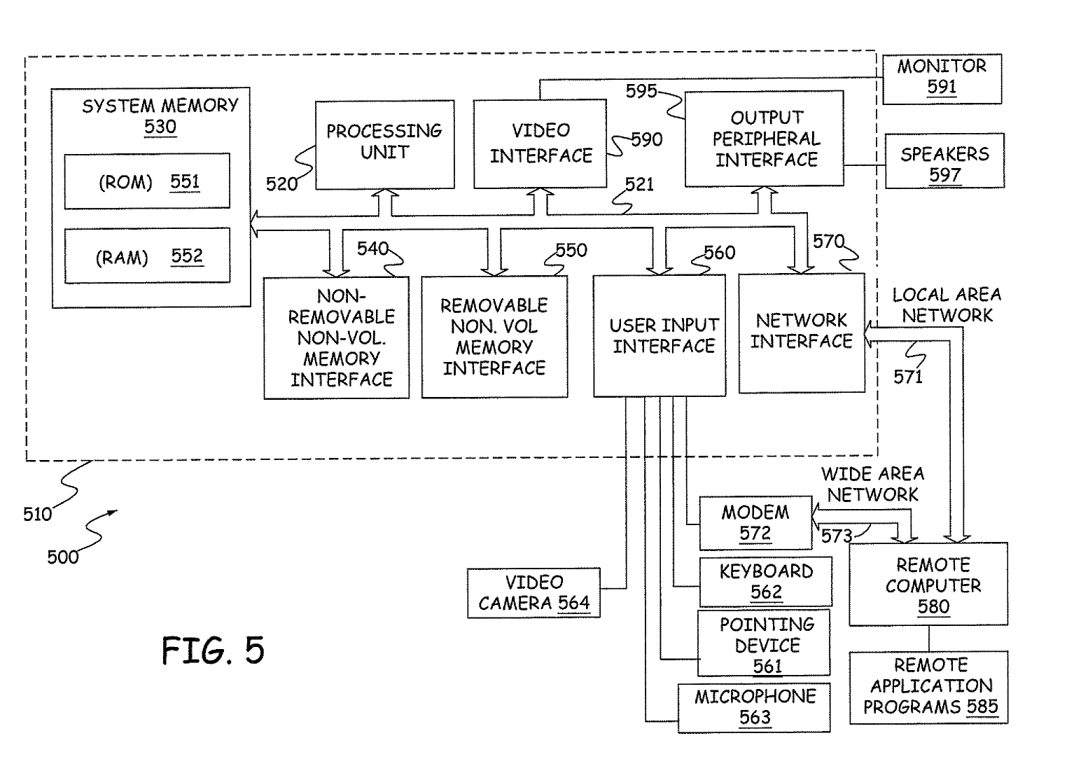

The above description of illustrative embodiments is described in accordance with a network-based service environment having a service agent and client devices. Below are suitable computing environments that can incorporate and benefit from these embodiments. The computing environment shown in FIG. 5 is one such example that can be used to implement the service agent and/or be implemented as a client device.

In FIG. 5, the computing system environment 500 is only one example of a suitable computing environment and is not intended to suggest any limitation as to the scope of use or functionality of the claimed subject matter. Neither should the computing environment 500 be interpreted as having any dependency or requirement relating to any one or combination of components illustrated in the exemplary computing environment 500.

Computing environment 500 illustrates a general purpose computing system environment or configuration. Examples of well-known computing systems, environments, and/or configurations that may be suitable for use with the service agent or a client device include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Concepts presented herein may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

Exemplary environment 500 for implementing the above embodiments includes a general-purpose computing system or device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data.

The system memory 530 includes computer storage media in the form of volatile and/or nonvolatile memory such as read only memory (ROM) 131 and random access memory (RAM) 532. The computer 510 may also include other removable/non-removable volatile/nonvolatile computer storage media. Non-removable non-volatile storage media are typically connected to the system bus 521 through a non-removable memory interface such as interface 540. Removeable non-volatile storage media are typically connected to the system bus 521 by a removable memory interface, such as interface 550.

A user may enter commands and information into the computer 510 through input devices such as a keyboard 562, a microphone 563, a pointing device 561, such as a mouse, trackball or touch pad, and a video camera 564. These and other input devices are often connected to the processing unit 520 through a user input interface 560 that is coupled to the system bus, but may be connected by other interface and bus structures, such as a parallel port or a universal serial bus (USB). A monitor 591 or other type of display device is also connected to the system bus 521 via an interface, such as a video interface 590. In addition to the monitor, computer 510 may also include other peripheral output devices such as speakers 597, which may be connected through an output peripheral interface 595.

The computer 510, when implemented as a client device or as a service agent, is operated in a networked environment using logical connections to one or more remote computers, such as a remote computer 580. The remote computer 580 may be a personal computer, a hand-held device, a server, a router, a network PC, a peer device or other common network node, and typically includes many or all of the elements described above relative to the computer 510. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on remote computer 580. It will be appreciated that the network connections shown are exemplary and other means of establishing a communications link between computers may be used.

Besides computer 510 being used as a client device, mobile devices can also be used as client devices. Mobile devices can be used in various computing settings to utilize service agent 216 across the network-based environment. For example, mobile devices can interact with service agent 216 using natural language input of different modalities including text and speech. The mobile device as discussed below is exemplary only and is not intended to limit the present invention described herein.

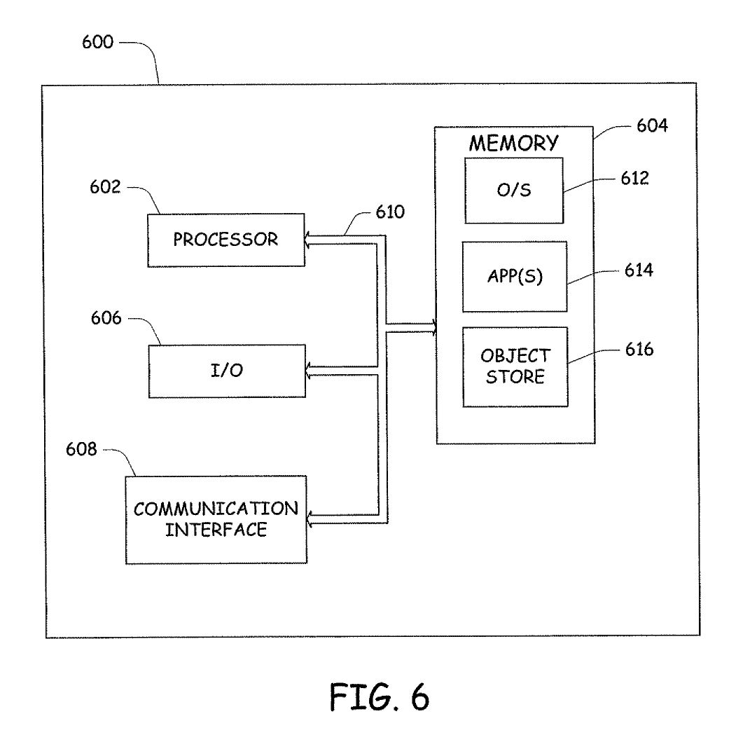

FIG. 6 is a block diagram of a data management mobile device 600, which is an exemplary client device for the network-based service environment 100. Mobile device 600 includes a microprocessor 602, memory 604, input/output (I/O) components 606, and a communication interface 608 for communicating with remote computers or other mobile devices. In one embodiment, the aforementioned components are coupled for communication with one another over a suitable bus 610.

Memory 604 is implemented as non-volatile electronic memory such as random access memory (RAM) with a battery backup module (not shown) such that information stored in memory 604 is not lost when the general power to mobile device 600 is shut down. A portion of memory 604 is preferably allocated as addressable memory for program execution, while another portion of memory 604 is preferably used for storage, such as to simulate storage on a disk drive.

Communication interface 608 represents numerous devices and technologies that allow mobile device 600 to send and receive information. The devices include wired and wireless modems, satellite receivers and broadcast tuners to name a few. Mobile device 600 can also be directly connected to a computer to exchange data therewith. In such cases, communication interface 608 can be an infrared transceiver or a serial or parallel communication connection, all of which are capable of transmitting streaming information.

Input/output components 606 include a variety of input devices such as a touch-sensitive screen, buttons, rollers, and a microphone as well as a variety of output devices including an audio generator, a vibrating device, and a display. The devices listed above are by way of example and need not all be present on mobile device 600. In addition, other input/output devices may be attached to or found with mobile device 600.

Mobile device 600 can also include an optional recognition program (speech, DTMF, handwriting, gesture or computer vision) stored in memory 604. By way of example, in response to audible information, instructions or commands from a microphone provides speech signals, which are digitized by an A/D converter. The speech recognition program can perform normalization and/or feature extraction functions on the digitized speech signals to obtain intermediate speech recognition results. Similar processing can be used for other forms of input. For example, handwriting input can be digitized with or without pre-processing on device 600. Like the speech data, this form of input can be transmitted to a server for recognition wherein the recognition results are returned to at least one of the device 600 and/or a remote agent. Likewise, DTMF data, gesture data and visual data can be processed similarly. Depending on the form of input, device 600 would include necessary hardware such as a camera for visual input.

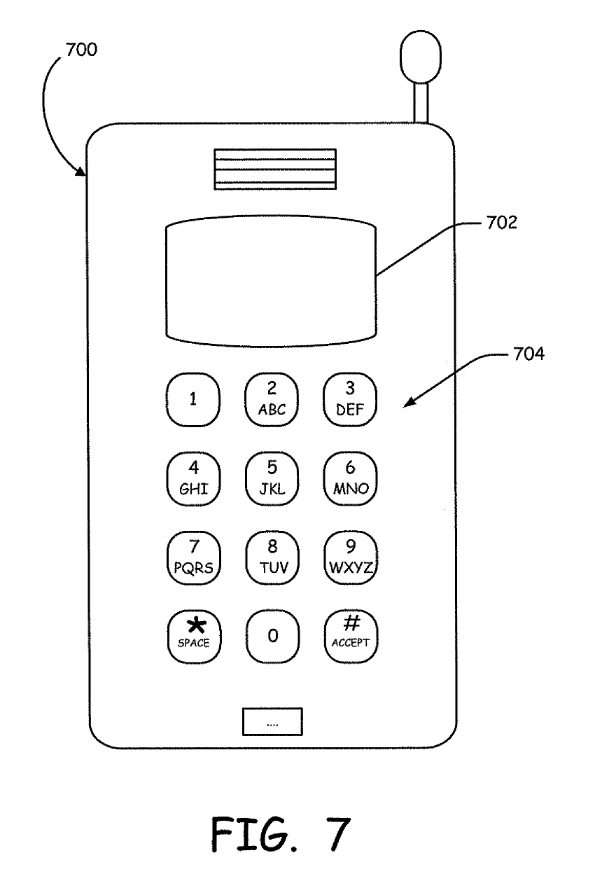

FIG. 7 is a plan view of an exemplary embodiment of a portable phone 700. The phone 700 includes a display 702 and a keypad 704. Generally, the block diagram of FIG. 6 applies to the phone of FIG. 7, although additional circuitry necessary to perform other functions may be required. For instance, a transceiver necessary to operate as a phone will be required for the embodiment of FIG. 6.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
receiving a voice query containing contact information;
associating the voice query with a particular contact entity from a plurality of contact entities based on the contact information;
accessing status information for the particular contact entity, the status information including a presence indicator set by the particular contact entity; and
performing a task based on the status information.

2. The method of claim 1 wherein the task includes forming a voice connection with the particular contact entity.

3. The method of claim 1 wherein the task includes checking status information from a list of individuals associated with the particular contact entity.

4. The method of claim 1 wherein the task includes forming a connection with a plurality of individuals associated with the particular contact entity.

5. The method of claim 1 wherein the task includes forming a connection with the particular contact entity when the presence indicator for the particular contact entity is available.

6. The method of claim 1 wherein the task includes rendering the status information.

7. The method of claim 1 wherein accessing includes accessing status information from a plurality of messaging services.

8. The method of claim 1 wherein the voice query further contains a desired status for forming a connection.

9. A system, comprising:
a personal information manager containing contact information for a plurality of contact entities;
a communication application programming interface adapted to receive information from and transmit information to a network; and
a module operably coupled to the personal information manager and the communication application programming interface, the module adapted to receive a voice query from the network, associate the voice query with a particular contact entity from the plurality of contact entities, access status information for the particular contact entity from the network, the status information including a presence indicator set by the particular contact entity and perform a task based on the status information.

10. The system of claim 9 wherein the task includes forming a voice connection with the particular contact entity.

11. The system of claim 9 wherein the task includes checking status information from a list of individuals associated with the particular contact entity.

12. The system of claim 9 wherein the task includes forming a connection with a plurality of individuals associated with the particular contact entity.

13. The system of claim 9 wherein the task includes forming a connection with the particular contact entity when the presence indicator for the particular contact entity is available.

14. The system of claim 9 wherein the task includes rendering the status information.

15. The system of claim 9 wherein accessing includes accessing status information from a plurality of messaging services.

16. The system of claim 9 wherein the voice query further contains a desired status for forming a connection.

17. A method of forming a communication connection across a network, comprising:
accessing contact information using a first messaging service having a plurality of contact entities;
receiving a query related to a particular contact entity from the plurality of contact entities;
accessing status information for the particular contact entity from a second messaging service that is different from the first messaging service; and
performing a task based on the status information for the particular contact entity.

18. The method of claim 17 wherein the query is a voice query and the task includes forming a voice connection with the particular contact entity.

19. The method of claim 17 wherein the particular contact entity includes a group of persons.

20. The method of claim 17 wherein the first messaging service is one of MSN Messenger, Yahoo! Messenger and Google Talk and the second messaging service is one of MSN Messenger, Yahoo! Messenger and Google Talk.
